(19) United States
(12) Patent Application Publication
(10) Pub. No.: US 2022/0362598 A1
(43) Pub. Date: Nov. 17, 2022

(54) CARTRIDGE MONITORING SYSTEM AND COUPLER

(71) Applicant: Tyco Fire Products LP, Lansdale, PA (US)

(72) Inventors: Donald M. Bjorkman, Menominee, MI (US); Steven M. Noha, Menominee, MI (US); Patrick S. Cirilli, Peshtigo, WI (US)

(73) Assignee: Tyco Fire Products LP, Lansdale, PA (US)

(21) Appl. No.: 17/771,774

(22) PCT Filed: Oct. 29, 2020
(86) PCT No.: PCT/IB2020/060179

§ 371 Date: Apr. 25, 2022

Related U.S. Application Data
(60) Provisional application No. 62/928,570, filed on Oct. 31, 2019.

(51) Int. Cl. A62C 37/50; A62C 37/44; G08B 17/06

(52) U.S. Cl. CPC A62C 37/50; A62C 37/44; G08B 17/06

(57) ABSTRACT

A receiver for a fire suppression system includes a receiving portion configured to receive and couple with a corresponding portion of a cartridge. The receiver includes a translatable member configured to engage a corresponding portion of the cartridge and translate in response to insertion of the cartridge. The receiver includes a switch configured to transition between a first state and a second state in response to translation of the translatable member to indicate whether the cartridge is inserted into the receiving portion.

### CROSS-REFERENCE TO RELATED PATENT APPLICATION

This application claims the benefit of and priority to U.S. Provisional Application No. 62/928,570, filed Oct. 31, 2019, the entire disclosure of which is incorporated by reference herein.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppression agent throughout the area. The fire suppressant agent then extinguishes or controls (e.g., prevents the growth of) the fire.

### SUMMARY

One implementation of the present disclosure is a receiver for a fire suppression system, according to some embodiments. In some embodiments, the receiver includes a receiving portion configured to receive and couple with a portion of a cartridge. In some embodiments, the receiver includes a translatable member configured to translate in response to insertion of the portion of the cartridge into the receiving portion. In some embodiments, the receiver includes a switch configured to transition between a first state and a second state in response to translation of the translatable member to indicate whether the cartridge is inserted into the receiving portion.

Another implementation of the present disclosure is a fire suppression system, according to some embodiments. In some embodiments, the fire suppression system includes one or more fire suppressant tanks configured to provide fire suppressant agent to one or more nozzles. In some embodiments, the fire suppression system also includes one or more cartridges configured to be selectively fluidly coupled with the fire suppressant tanks. In some embodiments, the fire suppression system includes a receiver configured to fluidly couple the one or more cartridges with the one or more fire suppressant tanks. In some embodiments, the receiver includes a receiving portion configured to receive and couple with a corresponding portion of the cartridge. The receiver can also include a movable member configured to translate in response to insertion of the portion of the cartridge into the receiving portion, and a switch configured to transition between a first state and a second state in response to movement of the movable member to indicate whether the cartridge is inserted into the receiving portion.

Another implementation of the present disclosure is a fire suppression system, according to some embodiments. In some embodiments, the fire suppression system includes a translatable member, a switch, and a controller. The translatable member is configured to translate in response to insertion of apportion of a cartridge into a receiver, according to some embodiments. The switch is configured to transition between a first state and a second state in response to translation of the translatable member to indicate whether the cartridge is inserted, according to some embodiments. The controller is configured to receive status signals from the switch that indicate whether the switch is in the first state or the second state, according to some embodiments.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description, taken in conjunction with the accompanying FIGURES, wherein like reference numerals refer to like elements, in which:

FIG. 1 is a schematic of a fire suppression system, according to some embodiments.

FIG. 2 is a perspective view of a cartridge and a coupling of the fire suppression system of FIG. 1, according to some embodiments.

FIG. 3 is a perspective view of the coupling of FIG. 2, according to some embodiments.

FIG. 4 is a side sectional view of a coupling of the fire suppression system of FIG. 1 in a position when the cartridge is not fully inserted, according to some embodiments.

FIG. 5 is a side sectional view of the coupling of FIG. 4 in a position when the cartridge is fully inserted, according to some embodiments.

FIG. 6 is a side sectional view showing translations of various members of the coupling of FIGS. 4-5 as the cartridge is inserted into the coupling, according to some embodiments.

FIG. 7 is a block diagram of a control system for monitoring the cartridge of FIGS. 2-6, according to some embodiments.

FIG. 8 is a flow diagram of a process for monitoring insertion of a cartridge and operation of any of an aural alert device, a visual alert device, or a fire suppression system based on insertion of the cartridge, according to some embodiments.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, a coupling for a cartridge of a fire suppression system includes a switch that is transitionable between an open state and a first state. The cartridge can be a capsule, tank, cylinder, or a similar component that includes an inner volume and stores a fire suppressant agent, a compressed gas, etc. therewithin. In some embodiments, the coupling includes a receiving aperture configured to receive a portion of the cartridge so the coupling may removably couple with the cartridge or with a corresponding portion (e.g., a neck) of the cartridge. The coupling can include threads (e.g., along an inner surface of the aperture) that are configured to threadingly couple with corresponding threads on the cartridge. As the cartridge is inserted (or threaded into) the receiving aperture, a portion of the cartridge engages a translatable member (e.g., a bracket, a pin, etc.). In some embodiments, the translatable member directly engages the switch such that translation of the translatable member transitions the switch between the open state and the closed state. In other embodiments, the translatable member engages a second translatable member that directly or indirectly engages the switch. One or more springs can be positioned in the coupling to provide a biasing force to the translatable member.

The switch may transition from the open state to the closed state in response to insertion of the cartridge. In some embodiments, the switch provides status signals to a controller or closes a circuit. A light emitting device or a sound emitting device (e.g., a notification device, an alert device, a warning device, etc.) can be configured to receive signals from the controller or may be electrically connected on the circuit. The controller can provide the light emitting device or the sound emitting device with signals that operate the light emitting device to emit light or operate the sound emitting device to emit sound to notify a technician or operator regarding an insertion status of the cartridge. In other embodiments, the light emitting device or the sound emitting device are electrically connected on the circuit such that the light emitting device or the sound emitting device activate (or de-activate) in response to insertion or removal of the cartridge. For example, the light emitting device can be configured to emit a green light and may activate in response to the cartridge being properly (e.g., fully) inserted into the coupling.

### Fire Suppression System

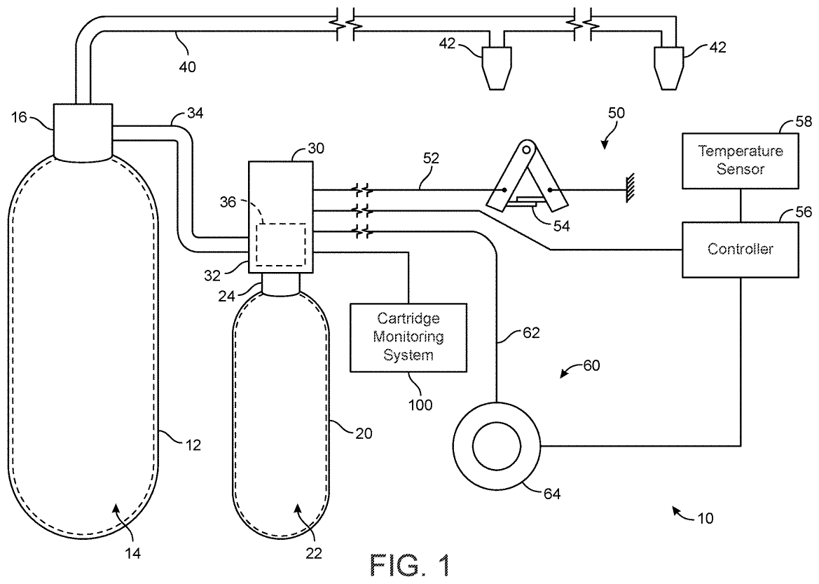

Referring to FIG. 1, a fire suppression system 10 is shown according to an exemplary embodiment. In one embodiment, fire suppression system 10 is a chemical fire suppression system. Fire suppression system 10 is configured to dispense or distribute a fire suppressant agent onto and/or nearby a fire, extinguishing the fire and preventing the fire from spreading. Fire suppression system 10 may be used alone or in combination with other types of fire suppression systems (e.g., a building sprinkler system, a handheld fire extinguisher, etc.). In some embodiments, multiple fire suppression systems 10 are used in combination with one another to cover a larger area (e.g., each in different rooms of a building).

Fire suppression system 10 may be used in a variety of different applications. Different applications may require different types of fire suppressant agent and different levels of mobility. Fire suppression system 10 is usable with a variety of different fire suppressant agents, such as powders, liquids, foams, or other fluid or flowable materials. Fire suppression system 10 may be used in a variety of stationary applications. By way of example, fire suppression system 10 is usable in kitchens (e.g., for oil or grease fires, etc.), in libraries, in data centers (e.g., for electronics fires, etc.), at filling stations (e.g., for gasoline or propane fires, etc.), or in other stationary applications. Alternatively, fire suppression system 10 may be used in a variety of mobile applications. By way of example, fire suppression system 10 may be incorporated into land-based vehicles (e.g., racing vehicles, forestry vehicles, construction vehicles, agricultural vehicles, mining vehicles, passenger vehicles, refuse vehicles, etc.), airborne vehicles (e.g., jets, planes, helicopters, etc.), or aquatic vehicles, (e.g., ships, submarines, etc.).

Referring again to FIG. 1, fire suppression system 10 includes a fire suppressant tank 12 (e.g., a vessel, container, vat, drum, tank, canister, pressure vessel, cartridge, or can, etc.). Fire suppressant tank 12 defines an internal volume 14 filled (e.g., partially, completely, etc.) with fire suppressant agent. In some embodiments, the fire suppressant agent is normally not pressurized (e.g., is near atmospheric pressure). Fire suppressant tank 12 includes an exchange section, shown as neck 16. Neck 16 permits the flow of expellant gas into internal volume 14 and the flow of fire suppressant agent out of internal volume 14 so that the fire suppressant agent may be supplied to a fire.

Fire suppression system 10 further includes a cartridge 20 (e.g., a vessel, container, vat, drum, tank, canister, pressure vessel, cartridge, or can, etc.). Cartridge 20 defines an internal volume 22 configured to contain a volume of pressurized expellant gas. The expellant gas may be an inert gas. In some embodiments, the expellant gas is air, carbon dioxide, or nitrogen. Cartridge 20 includes an outlet portion or outlet section, shown as neck 24. Neck 24 defines an outlet fluidly coupled to internal volume 22. Accordingly, the expellant gas may leave cartridge 20 through neck 24. Cartridge 20 may be rechargeable or disposable after use. In some embodiments where cartridge 20 is rechargeable, additional expellant gas may be supplied to internal volume 22 through neck 24.

Fire suppression system 10 further includes a valve, puncture device, or activator assembly, shown as actuator 30. Actuator 30 includes an adapter, a coupler, an interfacing member, a receiving member, an engagement member, etc., shown as receiver 32, that is configured to receive neck 24 of cartridge 20. Neck 24 is selectively coupled to the receiver 32 (e.g., through a threaded connection, etc.). Decoupling cartridge 20 from actuator 30 facilitates removal and replacement of cartridge 20 when cartridge 20 is depleted. Actuator 30 is fluidly coupled to neck 16 of fire suppressant tank 12 through a conduit, tubular member, pipe, fixed pipe, piping system, etc., shown as hose 34.

Actuator 30 includes an activation mechanism 36 configured to selectively fluidly couple internal volume 22 to neck 16. In some embodiments, activation mechanism 36 includes one or more valves that selectively fluidly couple internal volume 22 to hose 34. The valves may be mechanically, electrically, manually, or otherwise actuated. In some such embodiments, neck 24 includes a valve that selectively prevents the expellant gas from flowing through neck 24. Such a valve may be manually operated (e.g., by a lever or knob on the outside of cartridge 20, etc.) or may open automatically upon engagement of neck 24 with actuator 30. Such a valve facilitates removal of cartridge 20 prior to depletion of the expellant gas. In other embodiments, cartridge 20 is sealed, and activation mechanism 36 includes a pin, knife, nail, or other sharp object that actuator 30 forces into contact with cartridge 20. This punctures the outer surface of cartridge 20, fluidly coupling internal volume 22 with actuator 30. In some embodiments, activation mechanism 36 punctures cartridge 20 only when actuator 30 is activated. In some such embodiments, activation mechanism 36 omits any valves that control the flow of expellant gas to hose 34. In other embodiments, activation mechanism 36 automatically punctures cartridge 20 as neck 24 engages actuator 30.

Once actuator 30 is activated and cartridge 20 is fluidly coupled to hose 34, the expellant gas from cartridge 20 flows freely through neck 24, actuator 30, and hose 34 and into neck 16. The expellant gas forces fire suppressant agent from fire suppressant tank 12 out through neck 16 and into a conduit or hose, shown as pipe 40. In one embodiment, neck 16 directs the expellant gas from hose 34 to a top portion of internal volume 14. Neck 16 defines an outlet (e.g., using a syphon tube, etc.) near the bottom of fire suppressant tank 12. The pressure of the expellant gas at the top of internal volume 14 forces the fire suppressant agent to exit through the outlet and into pipe 40. In other embodiments, the expellant gas enters a bladder within fire suppressant tank 12, and the bladder presses against the fire suppressant agent to force the fire suppressant agent out through neck 16. In yet other embodiments, pipe 40 and hose 34 are coupled to fire suppressant tank 12 at different locations. By way of example, hose 34 may be coupled to the top of fire suppressant tank 12, and pipe 40 may be coupled to the bottom of fire suppressant tank 12. In some embodiments, fire suppressant tank 12 includes a burst disk that prevents the fire suppressant agent from flowing out through neck 16 until the pressure within internal volume 14 exceeds a threshold pressure. Once the pressure exceeds the threshold pressure, the burst disk ruptures, permitting the flow of fire suppressant agent. Alternatively, fire suppressant tank 12 may include a valve, a puncture device, or another type of opening device or activator assembly that is configured to fluidly couple internal volume 14 to pipe 40 in response to the pressure within internal volume 14 exceeding the threshold pressure. Such an opening device may be configured to activate mechanically (e.g., the force of the pressure causes the opening device to activate, etc.) or the opening device may include a separate pressure sensor in communication with internal volume 14 that causes the opening device to activate.

Pipe 40 is fluidly coupled to one or more outlets or sprayers (e.g., nozzles, sprinkler heads, discharge devices, dispersion devices, etc.), shown as nozzles 42. The fire suppressant agent flows through pipe 40 and to nozzles 42. Nozzles 42 each define one or more apertures, through which the fire suppressant agent exits, forming a spray of fire suppressant agent that covers a desired area. The sprays from nozzles 42 then suppress or extinguish fire within that area. The apertures of nozzles 42 may be shaped to control the spray pattern of the fire suppressant agent leaving nozzles 42. Nozzles 42 may be aimed such that the sprays cover specific points of interest (e.g., a specific piece of restaurant equipment, a specific component within an engine compartment of a vehicle, etc.). Nozzles 42 may be configured such that all of nozzles 42 activate simultaneously, or nozzles 42 may be configured such that only nozzles 42 near the fire are activated.

Fire suppression system 10 further includes an automatic activation system 50 that controls the activation of actuator 30. Automatic activation system 50 is configured to monitor one or more conditions and determine if those conditions are indicative of a nearby fire. Upon detecting a nearby fire, automatic activation system 50 activates actuator 30, causing the fire suppressant agent to leave nozzles 42 and extinguish the fire.

In some embodiments, actuator 30 is controlled mechanically. As shown in FIG. 1, automatic activation system 50 includes a mechanical system including a tensile member (e.g., a rope, a cable, etc.), shown as cable 52, that imparts a tensile force on actuator 30. Without this tensile force, actuator 30 will activate. The cable 52 is coupled to a fusible link 54, which is in turn coupled to a stationary object (e.g., a wall, the ground, etc.). The fusible link 54 includes two plates that are held together with a solder alloy having a predetermined melting point. A first plate is coupled to the cable 52, and a second plate is coupled to the stationary object. When the ambient temperature surrounding the fusible link 54 exceeds the melting point of the solder alloy, the solder melts, allowing the two plates to separate. This releases the tension on the cable 52, and actuator 30 activates. In other embodiments, automatic activation system 50 is another type of mechanical system that imparts a force on actuator 30 to activate actuator 30. Automatic activation system 50 may include linkages, motors, hydraulic or pneumatic components (e.g., pumps, compressors, valves, cylinders, hoses, etc.), or other types of mechanical components configured to activate actuator 30. Some parts of automatic activation system 50 (e.g., a compressor, hoses, valves, and other pneumatic components, etc.) may be shared with other parts of fire suppression system 10 (e.g., manual activation system 60) or vice versa.

Actuator 30 may additionally or alternatively be configured to activate in response to receiving an electrical signal from automatic activation system 50. Referring to FIG. 1, automatic activation system 50 includes a controller 56 that monitors signals from one or more fire detectors or sensors, shown as temperature sensor 58 (e.g., thermocouples, resistance temperature detectors, etc.). Controller 56 may use the signals from the temperature sensor 58 to determine if an ambient temperature has exceeded a threshold temperature. Upon determining that the ambient temperature has exceeded the threshold temperature, controller 56 provides an electrical signal to actuator 30. Actuator 30 then activates in response to receiving the electrical signal.

Fire suppression system 10 further includes a manual activation system 60 that controls the activation of actuator 30. Manual activation system 60 is configured to activate actuator 30 in response to an input from an operator. Manual activation system 60 may be included instead of or in addition to automatic activation system 50. Both automatic activation system 50 and manual activation system 60 may activate actuator 30 independently. By way of example, automatic activation system 50 may activate actuator 30 regardless of any input from manual activation system 60, and vice versa.

As shown in FIG. 1, manual activation system 60 includes a mechanical system including a tensile member (e.g., a rope, a cable, etc.), shown as cable 62, coupled to actuator 30. Cable 62 is coupled to a human interface device (e.g., a button, a lever, a switch, a knob, a pull ring, etc.), shown as button 64. Button 64 is configured to impart a tensile force on cable 62 when pressed, and this tensile force is transferred to actuator 30. Actuator 30 activates upon experiencing the tensile force. In other embodiments, manual activation system 60 is another type of mechanical system that imparts a force on actuator 30 to activate actuator 30. Manual activation system 60 may include linkages, motors, hydraulic or pneumatic components (e.g., pumps, compressors, valves, cylinders, hoses, etc.), or other types of mechanical components configured to activate actuator 30.

Actuator 30 may additionally or alternatively be configured to activate in response to receiving an electrical signal from manual activation system 60. As shown in FIG. 1, button 64 is operably coupled to controller 56. Controller 56 may be configured to monitor the status of a human interface device or user input device (e.g., engaged, disengaged, etc.). Upon determining that the human interface device is engaged, the controller provides an electrical signal to activate actuator 30. By way of example, controller 56 may be configured to monitor a signal from button 64 to determine if button 64 is pressed. Upon detecting that button 64 has been pressed, controller 56 sends an electrical signal to actuator 30 to activate actuator 30.

Automatic activation system 50 and manual activation system 60 are shown to activate actuator 30 both mechanically (e.g., though application of a tensile force through cables, through application of a pressurized liquid, through application of a pressurized gas, etc.) and electrically (e.g., by providing an electrical signal). It should be understood, however, that automatic activation system 50 and/or manual activation system 60 may be configured to activate actuator 30 solely mechanically, solely electrically, or through some combination of both. By way of example, automatic activation system 50 may omit controller 56 and activate actuator 30 based on the input from the fusible link 54. By way of another example, automatic activation system 50 may omit the fusible link 54 and activate actuator 30 using an input from controller 56.

### Cartridge Monitoring System

Referring further to FIG. 1, fire suppression system 10 further includes a cartridge monitoring system 100. Cartridge monitoring system 100 is configured to detect whether or not cartridge 20 is engaged with actuator 30. In response to detecting that cartridge 20 is not engaged with actuator 30, cartridge monitoring system 100 provides a notification to an operator. Cartridge monitoring system 100 prevents accidental omission of cartridge 20 from fire suppression system 10, which would prevent fire suppression system 10 from operating properly.

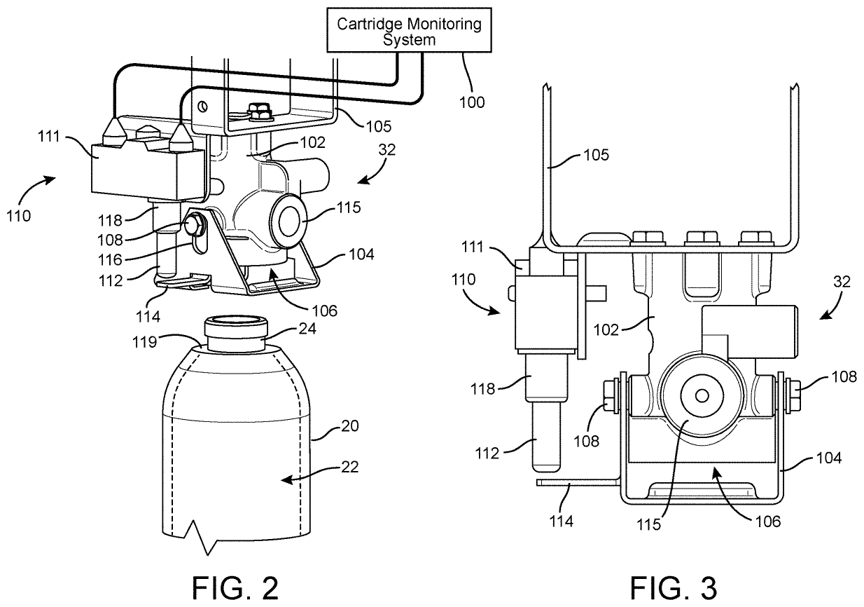

Referring now to FIGS. 2 and 3, receiver 32 and cartridge monitoring system 100 are shown in greater detail, according to some embodiments. In some embodiments, receiver 32 includes a bracket 105 that is configured to support a body section, a receiving member, a body member, etc., shown as body 102. Body 102 includes an aperture, an inner volume, a receiving aperture, etc., shown as receiving portion 106. Receiving portion 106 is configured to receive neck 24 of cartridge 20 therewithin and fluidly couple internal volume 22 of cartridge 20 with internal volume 14 of fire suppressant tank 12 (shown in FIG. 1). In some embodiments, receiving portion 106 is an inner volume that is fluidly coupled with an outlet tubular member 115 that protrudes laterally from body 102. Outlet tubular member 115 is configured to fluidly couple with hose 34 to fluidly couple internal volume 22 of cartridge 20 with internal volume 14 of fire suppressant tank 12.

Receiver 32 includes a switch, a relay, etc., shown as switch 110. Switch 110 is configured to electrically couple with cartridge monitoring system 100 to indicate whether cartridge 20 has been inserted into, threaded into, or otherwise coupled with receiver 32. In some embodiments, switch 110 is configured to transition between an open state (e.g., a first state) and a closed state (e.g., a second state) in response to cartridge 20 being inserted into receiver 32. In some embodiments, switch 110 transitions out of the open state to the closed state in response to cartridge 20 being inserted into receiver 32. Switch 110 includes a first member 118, and a second member 112. Second member 112 can be received within first member 118. In some embodiments, second member 112 is configured to translate relative to first member 118. For example, second member 112 can be received within an inner volume of first member 118 and may be configured to slidably couple with or slidably engage a corresponding inner surface of first member 118. In some embodiments, first member 118 and second member 112 extend longitudinally along a side of body 102. In some embodiments, first member 118 and second member 112 are translationally fixedly coupled with a housing 111 of switch 110. Housing 111 of switch 110 can be fixedly coupled with bracket 105 or with body 102.

Receiver 32 includes one or more bolts, cylindrical members, guide member, protrusions, etc., shown as guide members 108. Guide members 108 extend laterally outwards (e.g., from opposite sides) of body 102. Guide members 108 are configured to be received within and slidably couple with a corresponding slot, recess, track, etc., of bracket 104, shown as slots 116. In some embodiments, bracket 104 is a U-shaped bracket that extends from a bottom end of body 102 of receiver 32. Bracket 104 can be any member configured to move (e.g., translate, pivot, etc.) in response to insertion of cartridge 20 into receiver 32. For example, bracket 104 can be configured to engage a corresponding portion of cartridge 20 and pivot or rotate in response to insertion of cartridge 20 in receiver 32.

Bracket 104 is configured to engage a corresponding shoulder of cartridge 20. In some embodiments, as cartridge 20 is inserted into receiver 32, a shoulder, step, surface, edge, face, neck, etc., of cartridge 20, shown as shoulder 119 engages portion of bracket 104. Bracket 104 is translatably coupled with body 102 through the slidable coupling of guide members 108 and slots 116. As cartridge 20 is inserted into receiver 32, bracket 104 is driven to translate longitudinally towards body 102. Bracket 104 includes a laterally extending member 114 that is configured to engage second member 112 as bracket 104 is translated towards body 102 (e.g., in an upwards direction in FIGS. 2 and 3). In some embodiments, laterally extending member 114 protrudes outwards from bracket 104 so that when bracket 104 translates or moves relative to body 102 (e.g., towards body 102), laterally extending member 114 contacts or engages second member 112. As cartridge 20 is inserted into receiver 32, laterally extending member 114 translates with bracket 104 and translates second member 112 relative to first member 118, thereby transitioning switch 110 from the open state to the closed state. In some embodiments, translation or movement of second member 112 relative to first member 118 closes a circuit within switch 110 that can be detected or monitored by cartridge monitoring system 100.

When switch 110 transitions into the closed state (e.g., from the open state) or once the circuit is closed, cartridge monitoring system 100 identifies that cartridge 20 has been fully inserted into receiver 32. In some embodiments, switch 110 is configured such that the circuit is only closed once second member 112 has translated a predetermined amount relative to first member 118 (e.g., a predetermined amount that cartridge 20 must translate to be fully inserted into receiver 32).

Cartridge monitoring system 100 can monitor or be a part of the circuit of switch 110. In some embodiments, switch 110 defaults to the open state when cartridge 20 is not inserted or is not inserted fully. In some embodiments, second member 112 is spring loaded relative to first member 118 such that second member 112 is biased to move to a fully extended position when cartridge 20 is not inserted into receiver 32. In response to cartridge 20 being fully inserted into receiver 32, second member 112 is driven to translate relative to first member 118 to close the circuit. Cartridge monitoring system 100 can monitor current passing through the circuit at switch 110, resistance across the circuit at switch 110, or voltage across the circuit at switch 110. In some embodiments, cartridge monitoring system 100 is configured to detect if switch 110 is transitioned between the open state and the closed state (e.g., if the circuit is opened or closed) to identify if cartridge 20 is fully inserted into receiver 32. In some embodiments, receiver 32 as shown in FIGS. 2-3 and described herein is used with a restaurant fire suppression system.

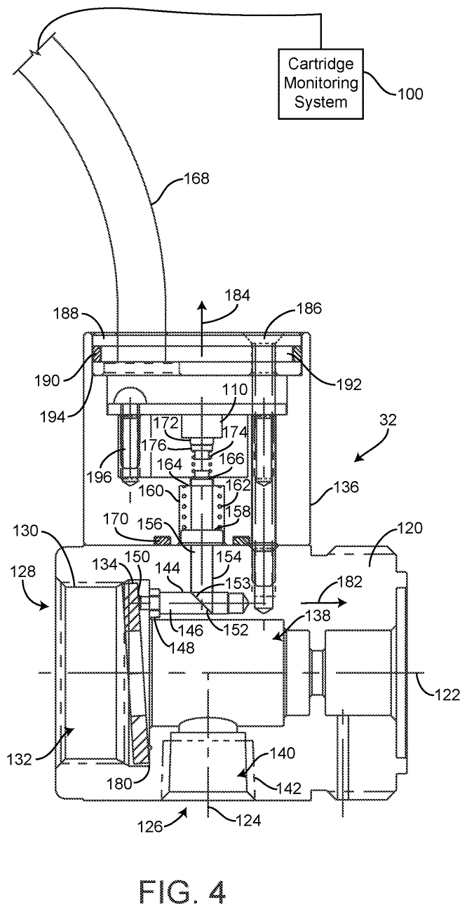

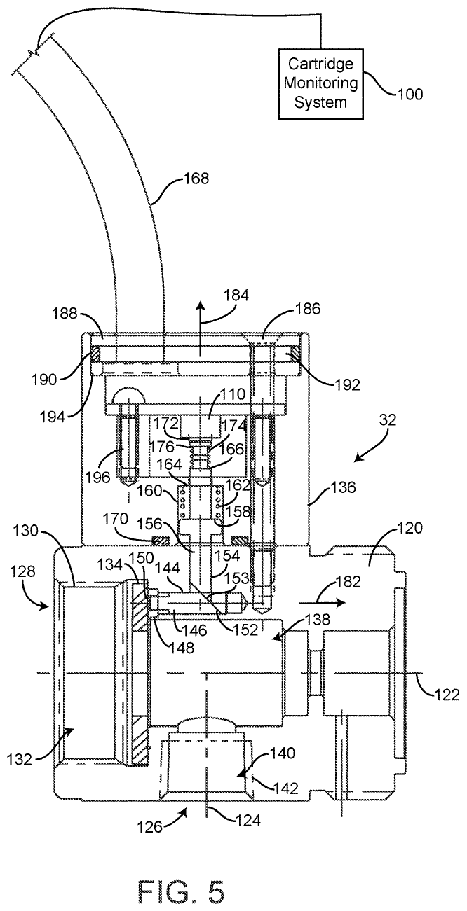

Referring particularly to FIGS. 4-5, receiver 32 is shown, according to another embodiment. FIG. 4 shows receiver 32 when cartridge 20 is not fully inserted or threaded into receiver 32. FIG. 5 shows receiver 32 when cartridge 20 is fully inserted or threaded into receiver 32. Receiver 32 includes a body portion, a body member, etc., shown as body 120 that is configured to receive and removably couple with cartridge 20 (e.g., at neck 24, see FIGS. 1 and 2). In some embodiments, receiver 32 includes an opening, a window, etc., shown as cartridge aperture 128. Cartridge aperture 128 fluidly couples with an inner volume 132 that neck 24 of cartridge 20 extends into to couple cartridge 20 with receiver 32. In some embodiments, receiver 32 includes threads 130 at inner volume 132 that are configured to threadingly couple or interface with corresponding threads of neck 24 to seal internal volume 22 of cartridge 20 with the various inner volumes of receiver 32.

Receiver 32 includes an O-shaped member, a disc, a flat member, a gasket, etc., shown as cartridge gasket 134. Cartridge gasket 134 is configured to be received within a corresponding portion of inner volume 132. In some embodiments, cartridge gasket 134 is configured to engage a corresponding shoulder, step, or surface of inner volume 132, shown as shoulder 180.

Cartridge gasket 134 includes an opening, a central aperture, a hole, etc., positioned at a center point of cartridge gasket 134. In some embodiments, the central aperture is configured to facilitate or allow the flow of fluid (e.g., fire suppressant agent) between inner volume 132 of receiver 32 and an inner chamber, an inner volume, a space, etc., shown as inner chamber 138. Inner chamber 138 and inner volume 132 can extend longitudinally at least partially through body 120 of receiver 32. In some embodiments, inner chamber 138 and inner volume 132 extend along longitudinal axis 122 that extends longitudinally through a center of body 120.

Body 120 includes a discharge passageway 140 that extends between inner chamber 138 of body 120 and the external environment. In some embodiments, discharge passageway 140 extends laterally from inner chamber 138 of body 120. In some embodiments, a lateral axis 124 extends through discharge passageway 140. Lateral axis 124 is substantially perpendicular with longitudinal axis 122.

Receiver 32 includes threads 142 at discharge passageway 140 that are configured to threadingly couple with corresponding threads of a tubular member that fluidly couples with discharge passageway 140. In some embodiments, discharge passageway 140 fluidly couples with an inner volume of the tubular member through outlet or discharge aperture 126. The tubular member can be hose 34 (shown in FIG. 1). In this way, fluid can enter body 120 through inlet aperture 128 and inner volume 132, pass through inner chamber 138 and inner discharge passageway 140, and be provided to the inner volume of hose 34 through discharge aperture 126.

Body 120 includes a channel, a bore, a hole, a recess, a cavity, a cylindrical cavity, etc., shown as bore 144. In some embodiments, bore 144 extends longitudinally through body 120. Bore 144 can be a blind hole that extends partially into body 120. In some embodiments, bore 144 is configured to receive and slidably or translatably couple with a correspondingly shaped pin, elongated member, cylindrical member, shown as first pin 146. First pin 146 includes a first or proximate end 150 that is configured to engage cartridge gasket 134. First pin 146 is configured to be received within and slide within bore 144 in response to cartridge 20 being inserted or threaded into inner volume 132 of body 120. In some embodiments, first end 150 of pin 146 engages a corresponding surface of cartridge gasket 134 or a corresponding surface of cartridge 20 (e.g., an outer surface of neck 24 of cartridge 20). First pin 146 can be retained in bore 144 by a retaining member, shown as pin keeper 148.

First pin 146 may be a longitudinally extending member that is configured to engage a second pin 156. In some embodiments, second pin 156 extends laterally through at least a portion of body 120. In some embodiments, second pin 156 extends through a bore 154 that extends laterally into body 120 to bore 144. First pin 146 includes a second or proximate end 152 that includes an angled surface. The angled surface at proximate end 152 is configured to engage or contact a corresponding angled surface of second pin 156. In some embodiments, the correspondingly angled surface of second pin 156 is a first or proximate end 153 of second pin 156.

Second pin 156 is translatable relative to bore 154. In some embodiments, second pin 156 is slidably coupled with bore 154. Second pin 156 can be driven to translate laterally in response to longitudinally translation of first pin 146 through the engagement between the correspondingly angled surfaces of first pin 146 and second pin 156. As cartridge 20 is inserted into or threaded into inlet aperture 128, first pin 146 is driven to translate further into bore 144 (e.g., to the right in FIG. 4). First pin 146 translates into bore 144 and engages or contacts second pin 156, thereby driving second pin 156 to translate laterally through bore 154.

Receiver 32 includes a lateral body member, a containment box, etc., shown as lateral body member 136. Lateral body member 136 is fixedly coupled with body 120 (e.g., with fasteners). In some embodiments, an O-ring or a seal 170 is positioned between corresponding mating surfaces of lateral body member 136 and body 120. Lateral body member 136 includes a channel, an opening, an aperture, a cavity, a recess, a bore, etc., shown as bore 160 that extends laterally. In some embodiments, bore 160 is centrally located about bore 154 when lateral body member 136 and body 120 are assembled (e.g., fixedly coupled with each other).

Second pin 156 extends through bore 160 of lateral body member 136. In some embodiments, second pin 156 includes a shoulder, an engagement surface, a step, an annular protrusion, an annular rib, etc., shown as engagement surface 158. Bore 160 includes a corresponding surface, engagement portion, etc., shown as contact surface 164. In some embodiments, contact surface 164 of bore 160 and engagement surface 158 of second pin 156 are faces that are substantially parallel with each other and offset a distance from each other. As second pin 156 translates within bore 144 and bore 160, the distance between engagement surface 158 of second pin 156 and contact surface 164 of bore 160 changes (e.g., decreases).

A first spring, a first biasing member, a first resilient member, etc., shown as first spring 162 is positioned within bore 160 and engages engagement surface 158 at a first end and contact surface 164 at a second end. First spring 162 may be a compression spring that biases second pin 156 into engagement with first pin 146. As first pin 146 translates laterally and drives second pin 156 to translate, first spring 162 can be transitioned into a compressed or partially compressed state. In such a state, first spring 162 exerts an expansive force between engagement surface 158 of second pin 156 and contact surface 164 of bore 160.

In some embodiments, contact surface 164 of bore 160 is a surface of a stepped portion of bore 160. Bore 160 can include a central aperture through which a second or distal end of second pin 156 (e.g., an end of second pin 156 that is opposite first end 153) extends. Second pin 156 includes a stepped portion, a shoulder, etc., shown as shoulder 166 at the second or distal end of second pin 156. Lateral body member 136 includes a button, a switch, a translatable member, etc., shown as button 172. In some embodiments, button 172 is a component of switch 110 that transitions switch 110 between the open state and the closed state when depressed (e.g., when button 172 is transitioned a predetermined amount).

Button 172 can engage or include a stepped portion 176. A second spring 174 is positioned within lateral body member 136 between shoulder 166 of second pin 156 and stepped portion 176. Shoulder 166 of second pin 156 is configured to engage or contact a first or proximate end of second spring 174 and stepped portion 176 is configured to engage a second or distal end of second spring 174. Second spring 174 can be a compression spring similar to first spring 162. In some embodiments, stepped portion 176 is a spring cap of second spring 174. Second spring 174 can function as a compensator spring. In some embodiments, first spring 162 is the primary spring with a higher K value, and second spring 174 is a secondary spring with a lower K value.

As cartridge 20 is inserted or threaded into cartridge aperture 128, cartridge gasket 134 can transition from the slightly angled position shown in FIG. 4 to the position shown in FIG. 5. As cartridge gasket 134 moves to the position shown in FIG. 5, first pin 146 is translated in a longitudinal direction 182. First pin 146 engages or contacts second pin 156 (e.g., at the interface between the angled surfaces at ends 152/153) and drives second pin 156 to translate in a lateral direction 184. Second pin 156 translates in lateral direction 184 and the spring cap (i.e., stepped portion 176) of second spring 174 presses button 172 of switch 110, thereby transitioning switch 110 from the open state to the closed state.

Cartridge monitoring system 100 monitors the status of switch 110 and can detect if switch 110 is in the open state or the closed state. Cartridge monitoring system 100 can be communicably and/or electrically coupled with switch 110 through a cable, a cord, a wire, etc., shown as cable 168. Lateral body member 136 includes an annular ring, an annular body member, a ring, a retaining member, etc., shown as retaining member 188. Retaining member 188 can be fastened to lateral body member 136. Retaining member 188 includes an annular groove, an annular channel, etc., shown as groove 192. Retaining member 188 is configured to be received within a corresponding groove, opening, aperture, etc., of lateral body member 136, shown as receiving portion 194. Retaining member 188 can engage a corresponding shoulder or surface of receiving portion 194 of lateral body member 136. Retaining member 188 can be a portion of switch 110 (e.g., a body portion of a circuit board that switch 110 couples with) that fixedly couples switch 110 with body member 136.

Retaining member 188 includes an O-ring, a seal, an annular seal, a flexible member, etc., shown as annular seal 190. Annular seal 190 is received within annular groove 192 and provides a seal between retaining member 188 and lateral body member 136. Cable 168 can extend through retaining member 188 and electrically and communicably couple with switch 110. A fastener 186 can removably couple retaining member 188 with lateral body member 136. In some embodiments, fastener 186 also removably couples lateral body member 136 with body 120. An additional fastener 196 can removably couple switch 110 with lateral body member 136. In other embodiments, lateral body member 136 and body 120 are fixedly coupled with each other using a combination of an adhesive, one or more fasteners, interlocking portions, etc. Likewise, retaining member 188 can be fixedly coupled with lateral body member 136 with a combination of any of an adhesive, one or more fasteners, interlocking portions, etc.

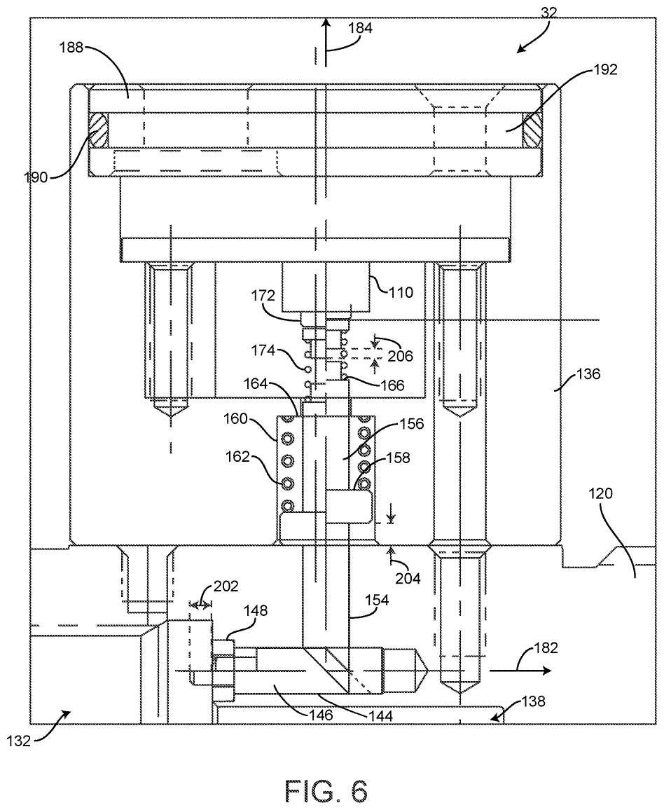

Referring particularly to FIG. 6, first pin 146 can be translated a distance 202 within bore 144 in a longitudinal direction (e.g., in direction 182). Translation of first pin 146 distance 202 drives second pin 156 to laterally translate distance 204 within bore 154. Translation of second pin 156 distance 204 drives button 172 to be depressed or translated a distance 206. However, distance 206 is less than distance 204. This is due to first spring 162 and second spring 174 being compressed some amount as second pin 156 translates laterally. Advantageously, first spring 162 and second spring 174 bias second pin 156 out of engagement with button 172. In this way, when cartridge 20 is not inserted or is not fully inserted into cartridge aperture 128, button 172 can be biased into the open state (e.g., a non-pressed position). Advantageously, first spring 162 and second spring 174 reduce the likelihood that button 172 bottoms out and breaks. For example, if button 172 bottoms out, first spring 162 and second spring 174 can compress as first pin 146 is translated, thereby preventing excessive forces from being provided to button 172 and preventing button 172 from being translated beyond its limit.

Advantageously, receiver 32 as described herein utilizes switch 110 and cartridge monitoring system 100 to monitor whether or not cartridge 20 is fully inserted into receiver 32. Cartridge monitoring system 100 can identify which state switch 110 is currently in (e.g., the open state or the closed state) and provide visual alerts or aural alerts based on the state. For example, cartridge monitoring system 100 can include a light emitting diode (LED) that transitions from a red color to a green color in response to cartridge 20 being fully inserted into receiver 32 (e.g., in response to switch 110 transitioning from the open state to the closed state, or vice versa).

Advantageously, receiver 32 as described with reference to FIGS. 4-6, includes first pin 146 positioned such that cartridge 20 must be inserted and threaded into inner volume 132. In this way, first pin 146 is only translated in response to cartridge 20 being inserted into inner volume 132 and threadingly coupled with body 120 through threads 130. Advantageously, switch 110 can detect if cartridge 20 is inserted into body 120 and can detect if cartridge 20 is properly inserted (e.g., fully tightened) into inner volume 132.

In some embodiments, switch 110 is electrically coupled with a circuit board. Switch 110 can detect or identify circuit continuity of cable 168. In some embodiments, switch 110 can detect if the circuit formed by switch 110 and cartridge monitoring system 100 is open due to cartridge 20 not being inserted into inner volume 132 or due to discontinuity in cable 168 (or any other cables, wires, cords, etc., that electrically and/or communicably couple switch 110 with cartridge monitoring system 100). In some embodiments, receiver 32 as described herein with reference to FIGS. 4-6 is used with a vehicle fire suppression system. In some embodiments, receiver 32 as described with reference to FIGS. 4-6 and shown in FIGS. 4-6 is smaller or more compact in size when compared to the receiver 32 as described with reference to FIGS. 2-3 and shown in FIGS. 2-3.

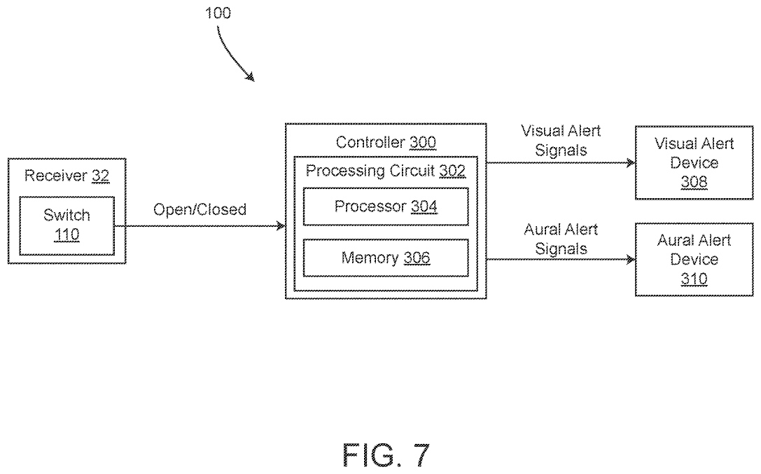

Referring particularly to FIG. 7, a block diagram of receiver 32 and cartridge monitoring system 100 is shown, according to some embodiments. In some embodiments, cartridge monitoring system 100 includes a controller 300 that is configured to receive status signals from switch 110 of receiver 32 that indicate which of the open or closed states switch 110 is currently in. In some embodiments, controller 300 is or includes any of the functionality of controller 56 (shown in FIG. 1). Controller 300 can use the status signals received from switch 110 to operate a visual alert device 308 and/or an aural alert device 310. In some embodiments, controller 300 is configured to generate visual alert signals and aural alert signals and provide the signals to visual alert device 308 and aural alert device 310. Visual alert device 308 can be an LED, a collection of LEDs, etc., or any other light emitting device. The various light emitting devices can be positioned about fire suppression system 10 to provide a visual indication of whether cartridge 20 is fully inserted into receiver 32. In some embodiments, controller 300 operates visual alert device 308 to transition between an activated and a deactivated state to provide the visual indication to an operator or technician. In some embodiments, controller 300 operates visual alert device 308 to transition between various colors (e.g., red, yellow, green, etc.). Controller 300 operates visual alert device 308 based on the status signals received from receiver 32.

Likewise, aural alert device 310 can be any sound emitting device capable of providing an aural alert to the operator or technician. In some embodiments, controller 300 operates aural alert device 310 based on the status signals received from switch 110. Controller 300 can operate aural alert device 310 to provide alert or warning sounds in response to cartridge 20 not being inserted into receiver 32 or in response to cartridge 20 being removed from receiver 32.

In some embodiments, switch 110 is a linear potentiometer. Controller 300 can receive status signals from switch 110 and determine a degree of insertion of cartridge 20. For example, controller 300 can use a relationship to relate a voltage signals received from switch 110 to the degree of insertion of cartridge 20 to determine if cartridge 20 is partially inserted, fully, inserted, or not inserted at all. In some embodiments, controller 300 transitions visual alert device 308 between various colors based on the degree of insertion of cartridge 20. For example, controller 300 may operate visual alert device 308 to emit a red color if cartridge 20 is not inserted into receiver 32, a yellow color if cartridge 20 is partially inserted into receiver 32, and a green color if cartridge 20 is fully inserted into receiver 32.

Still referring to FIG. 7, controller 300 is shown to include a processing circuit 302 including a processor 304 and memory 306. Processing circuit 302 can be communicably connected to a communications interface such that processing circuit 302 and the various components thereof can send and receive data via the communications interface. Processor 304 can be implemented as a general purpose processor, an application specific integrated circuit (ASIC), one or more field programmable gate arrays (FPGAs), a group of processing components, or other suitable electronic processing components.

Memory 306 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 306 can be or include volatile memory or non-volatile memory. Memory 306 can include database components, object code components, script components, or any other type of information structure for supporting the various activities and information structures described in the present application. According to some embodiments, memory 306 is communicably connected to processor 304 via processing circuit 302 and includes computer code for executing (e.g., by processing circuit 302 and/or processor 304) one or more processes described herein.

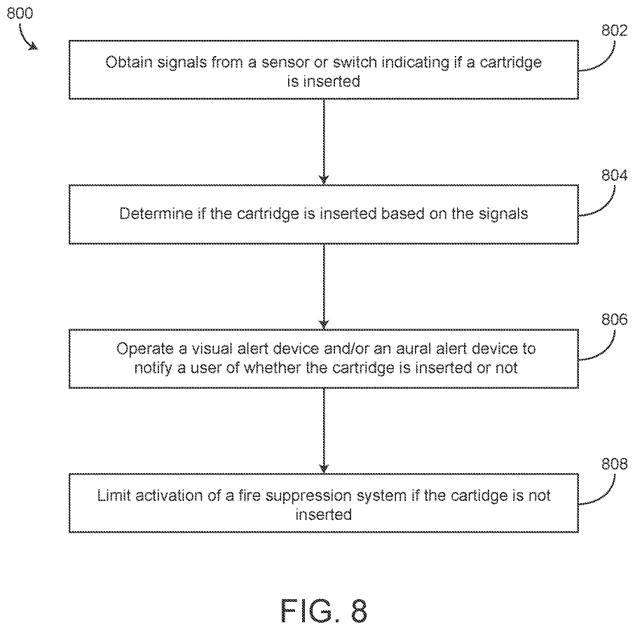

Referring now to FIG. 8, a process 800 for monitoring container insertion of a fire suppression system is shown, according to some embodiments. Process 800 includes steps 802-808, according to some embodiments. In some embodiments, process 800 is performed by cartridge monitoring system 100 and/or controller 300 as described in greater detail above with reference to FIG. 7.

Referring still to FIG. 8, process 800 includes obtaining signals from a sensor or switch indicating if a cartridge is inserted (step 802), according to some embodiments. Step 802 can be performed by controller 300 or controller 56. In some embodiments, the signals are obtained from switch 110. The signals can be provided to controller 300 or controller 56 via a wired or a wireless connection.

Process 800 includes determining if the cartridge is inserted based on the signals (step 804), according to some embodiments. In some embodiments, step 804 is performed by controller 300 or controller 56. The signals may indicate whether or not a cartridge (e.g., cartridge 20) has been inserted into a receiver or a receptacle (e.g., receiving portion 106, receiver 32, etc.). In some embodiments, the signals indicate if a switch (e.g., switch 110) has been actuated. The switch can be configured to actuate when the cartridge is inserted into the receiver or the receptacle.

Process 800 includes operating a visual alert device or an aural alert device to notify a user of whether the cartridge is inserted or not (step 806), according to some embodiments. In some embodiments, step 806 is performed by controller 300 (or controller 56) and visual alert device 308 and/or aural alert device 310. Step 806 can include operating the visual alert device to display a color that indicates if the cartridge is inserted (e.g., a red color if the cartridge is not inserted and a green color if the cartridge is inserted). Step 806 can also include operating the visual alert device in response to an activation event such as a user request to activate a fire suppression system (e.g., in response to a user input provided to controller 300 via a human machine interface or a user input device to activate fire suppression system 10) and/or a fire condition detection (e.g., in response to a monitored temperature exceeding a predetermined value, in response to optical sensor signals indicating that a fire condition or a fire is present, etc.). In some embodiments, step 806 includes operating the visual alert device and/or the aural alert device based on both the signals (e.g., based on a determination of whether the cartridge is inserted or not) and the activation event. For example, if the signals indicate that the cartridge is not inserted and the activation event occurs (e.g., indicating that the fire suppression system should be activated), step 806 can include operating the visual alert device and/or the aural alert device to notify a user or a technician that the cartridge is not inserted and should be inserted. In some embodiments, step 806 is performed concurrently or at least partially concurrently with step 808. In some embodiments, step 806 includes operating the visual alert device and/or the aural alert device continuously if the cartridge is not inserted. In some embodiments, step 808 includes operating the visual alert device and/or the aural alert devices in response to the activation event. In some embodiments, step 808 includes operating the visual alert device and/or the aural alert device according to different levels of alert. For example, the visual alert device may be operated continuously if the cartridge is not inserted, without operation of the aural alert device. However, once an activation event occurs (if the cartridge is still not inserted), step 806 may further include operating the aural alert device to prompt insertion of the cartridge in addition to operation of the visual alert device.

Process 800 include limiting activation of a fire suppression system (e.g., fire suppression system 10) if the cartridge is not inserted (step 808), according to some embodiments. In some embodiments, step 808 is performed by controller 300 and/or controller 56. In some embodiments, step 808 includes preventing activation of the fire suppression system if it is determined (e.g., based on the signals obtained in step 802) that the cartridge is not inserted. For example, if the cartridge is not inserted, the fire suppression system may be limited or prevented from activating even if an activation event occurs (e.g., a manual event such as a user input or an automatic event such as fire condition detection). In some embodiments, step 808 is performed concurrently or at least partially concurrently with step 806. In this way, insertion of the cartridge (or lack thereof) may be used to limit activation of the fire suppression system.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

1. A receiver for a fire suppression system, the receiver comprising:
a receiving portion configured to receive and couple with a portion of a cartridge;
an activation mechanism configured to selectively fluidly couple the cartridge with the receiver;
a translatable member configured to translate in response to insertion of the portion of the cartridge into the receiving portion; and
a switch configured to transition between a first state and a second state in response to translation of the translatable member to indicate whether the cartridge is inserted into the receiving portion.

2. The receiver of claim 1, wherein the receiving portion comprises an aperture and threads and the portion of the cartridge comprises a neck, wherein the threads of the receiving portion are configured to engage corresponding threads of the neck of the cartridge.

3. The receiver of claim 1, wherein the translatable member comprises a bracket having slots configured to slidably couple with corresponding protrusions of the receiver.

4. The receiver of claim 3, wherein the bracket comprises a protrusion extending outwards from the receiver and configured to engage the switch to transition the switch between the first state and the second state in response to insertion of the portion of the cartridge.

5. A fire suppression system comprising:
a fire suppressant tank configured to provide fire suppressant agent to a nozzle;
a cartridge configured to be selectively fluidly coupled with the fire suppressant tank;
a receiver configured to fluidly couple the cartridge with the fire suppressant tank, the receiver comprising:
a receiving portion configured to receive and couple with a corresponding portion of the cartridge;
a movable member configured to translate in response to insertion of the portion of the cartridge into the receiving portion; and
a switch configured to transition between a first state and a second state in response to movement of the movable member to indicate whether the cartridge is inserted into the receiving portion.

6. The fire suppression system of claim 5, wherein the receiving portion comprises an aperture and threads and the portion of the cartridge comprises a neck, wherein the threads of the receiving portion are configured to engage corresponding threads of the neck of the cartridge.

7. The fire suppression system of claim 5, wherein the movable member comprises a bracket having slots configured to slidably couple with corresponding protrusions of the receiver.

8. The fire suppression system of claim 7, wherein the bracket comprises a protrusion extending outwards from the receiver and configured to engage the switch to transition the switch between the first state and the second state in response to insertion of the portion of the cartridge.

9. The fire suppression system of claim 5, further comprising a cartridge monitoring system, wherein the cartridge monitoring system comprises a controller configured to receive status signals from the switch that indicate whether the switch is in the first state or the second state.

10. The fire suppression system of claim 9, wherein the controller is configured to operate a visual alert device or an aural alert device to provide a visual alert or an aural alert to an operator to indicate whether the cartridge is inserted into the receiver.

11. A fire suppression system, the fire suppression system comprising:
a translatable member configured to translate in response to engagement with an external portion of a cartridge during insertion of a second portion of a cartridge into a receiver;
a switch configured to transition between a first state and a second state in response to translation of the translatable member to indicate whether the cartridge is inserted; and
a controller configured to receive status signals from the switch that indicate whether the switch is in the first state or the second state.

12. The fire suppression system of claim 11, wherein the receiver comprises a receiving portion, wherein the receiving portion is configured to receive the second portion of the cartridge and comprises an aperture and threads, wherein the second portion of the cartridge comprises a neck, wherein the threads of the receiver are configured to engage corresponding threads of the neck of the cartridge.

13. (canceled)

14. The fire suppression system of claim 11, wherein the translatable member comprises a bracket having slots configured to slidably couple with corresponding protrusions of the receiver, and wherein the bracket comprises a protrusion extending outwards from the receiver and configured to engage the switch to transition the switch between the first state and the second state in response to insertion of the portion of the cartridge.

15. The fire suppression system of claim 11, wherein the controller is configured to operate a visual alert device or an aural alert device to provide a visual alert of an aural alert to an operator indicate whether the cartridge is inserted into the receiver.

16. The fire suppression system of claim 11, wherein the controller is configured to prevent activation of a fire suppression feature of the fire suppression system in response to the status signals from the switch indicating that the cartridge is not inserted into the receiver.

17. The fire suppression system of claim 11, wherein the controller is configured to receive a user input from a user device to activate the fire suppression system, and:
activate the fire suppression system if the status signals indicate that the cartridge is inserted into the receiver; or
prevent activation of the fire suppression system if the status signals indicate that the cartridge is not inserted into the receiver.

18. The fire suppression system of claim 11, wherein the switch actuates in a direction that is parallel with a direction of insertion of the cartridge.

19. The fire suppression system of claim 11, wherein the cartridge comprises an inner volume and is configured to store a fire suppressant agent.

20. The fire suppression system of claim 19, wherein the controller is configured to selectively fluidly couple the inner volume of the cartridge with an outlet tubular member of the receiver so that the fire suppressant agent is discharged from the cartridge through the receiver.

21. The fire suppression system of claim 12, wherein the translatable member engages with the external portion of the cartridge outside of the receiving portion.
